(19) United States
(12) Patent Application Publication
(10) Pub. No.: US 2025/0363152 A1
(43) Pub. Date: Nov. 27, 2025

(54) NATURAL LANGUAGE PROCESSING OVER A DOCUMENT REPOSITORY

(71) Applicant: Wells Fargo Bank, N.A., San Francisco, CA (US)

(72) Inventors: James D. Cahill, Belmont, MA (US); Nathan B. Coles, El Cerrito, CA (US); Luke N. deNatale, Grapevine, TX (US); Sean P. Hanrahan, Santa Monica, CA (US); Jack James Malpas-Coker, Dallas, TX (US); Tyus Pettis, San Francisco, CA (US)

(21) Appl. No.: 18/670,974

(22) Filed: May 22, 2024

(51) Int. Cl. G06F 16/33; G06F 16/383; G06F 40/30

(52) U.S. Cl. CPC G06F 16/3344; G06F 16/383; G06F 40/30

(57) ABSTRACT

System and techniques to use a document repository to enhance natural language processing are described herein. Text can be obtained from a conversation between two entities (e.g., a person, chatbot, etc.) in which one entity is making a request that may not be clear. The nature of the request is determined by semantically matching a part of the text to a document in a document repository. The nature of the document reveals the nature of the request in the text. The fields of the document can be used to provide prompts to continue the conversation to gather information used to fulfill the now identified request.

### TECHNICAL FIELD

Embodiments described herein generally relate to natural language processing by a computer and more specifically to natural language processing over a document repository.

### BACKGROUND

Natural Language Processing (NLP) is a field of artificial intelligence that focuses on the interaction between computers and human languages. It involves the development and application of computational techniques to analyze, interpret, and generate natural language content. NLP combines elements of computer science, linguistics, and data science to process and understand human language in a meaningful way. This includes tasks such as speech recognition, language translation, sentiment analysis, and text summarization. NLP systems use a variety of techniques, including statistical, machine learning, or deep learning techniques, among others, to model or analyze language structure or context. NLP enables computers to operate upon human language (e.g., understand, react to, etc.) in a useful and coherent manner.

Large language models (LLMs) are artificial intelligence (AI) systems trained to understand and generate human-like text. These models are trained on vast datasets containing a wide range of text from books, websites, and other written sources, enabling the models to incorporate the language patterns, context, or other subtleties of human communication. Once trained, LLMs can generate coherent and contextually relevant text based on input prompts, answering questions, creating content, or even engaging in dialogue. Generative AI, a broader category to which LLMs belong, refers to AI systems capable of creating new content, whether text, images, or music, that didn't exist before.

Document Management (DM) is a systematic approach to organizing, storing, and controlling access to documents within an organization. It involves the use of specialized software that provides a repository where documents of various types—including forms, text documents, spreadsheets, presentations, and multimedia files—are stored, managed, and tracked. DM systems facilitate efficient document retrieval, version control, and access permissions, ensuring that users can find and use the most current and accurate versions of documents. These systems often incorporate features such as metadata tagging, advanced search capabilities, workflow management, or audit trails to enhance document organization or traceability. By consolidating document storage and management processes, DM improves collaboration, enhances security and compliance with regulatory requirements, reduces redundancy, and streamlines business processes, leading to increased productivity and better information management across the organization.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for natural language processing over a document repository, according to an embodiment.

FIG. 2 illustrates an example of fining a semantic match between portions of a conversation and a document repository, according to an embodiment.

FIG. 3 illustrates an example of signaling between components, according to an embodiment.

FIG. 4 illustrates a flow diagram of an example of a method for natural language processing over a document repository, according to an embodiment.

FIG. 5 is a block diagram illustrating an example of a machine upon which one or more embodiments may be implemented.

### DETAILED DESCRIPTION

Document management and retrieval can be a daunting task in applications. While present DM systems typically rely on categories, keywords, indices, or other traditional database techniques to retrieve specific documents, a user creating such a query generally requires some knowledge of these document indicators to identify the desired document. If the types and numbers of documents become large, it can be difficult for a person to find the appropriate document. This issue can be magnified when the document sought is based on the needs of a person who is unfamiliar with the DM system in use. This can occur when, for example, a person comes to an organization seeking services that begin by filling out a document.

Consider a person entering an establishment to talk to a representative to have some need or want met, such as applying for social services. The representative listens to the expression of need or want and can try and interpret this expression into an appropriate query of the DM system to retrieve documents that will be completed to satisfy the need or want. If the document requires information not yet expressed by the person, or forgotten or unnoticed by the representative, the representative can ask additional questions to complete the document. This procedure can become time consuming and may require each representative to be proficient with the DM system and query parameters simply to find the documents. Populating the documents with information that may already have been expressed in the conversation with the person involves yet more time and can become frustrating for both the person and the representative.

To address these issues, NLP of the conversation can be implemented over a document repository, such as the DM. Here, contextual meaning from parts of speech from the conversation between the person and the representative can be derived from the documents in the DM. For example, embedding can be used on documents in the DM system as well as parts of the conversation to identify semantically similar documents. Embeddings in machine learning are numerical representations—a vector or array or numbers generally representing a scalar value in a dimension of the data—of complex data, such as words, sentences, or images, transformed into vectors in a continuous vector space. This representation enables the AI model to process and perform operations on this data more efficiently, capturing intricate relationships like similarity and context in a mathematically meaningful way. Documents identified can be used to identify other documents in the DM system via other DM techniques, such as categories, dependence chaining, etc. The identified document is also used to contextualize the requests of the person into a context appropriate for the representative. For example, if a person enters a pet adoption agency, discussions surrounding investments in the mining industry would be irrelevant. This will be reflected by a lack of semantic matching between an embedding in a comment about the mining industry and the forms in the DM system of the pet adoption agency.

Once the context of a person's request in the context of the DM system is ascertained, the content of the conversation can be used to prepopulate fields of the document (e.g., form), relieving the representative from, not only having to locate the document, but also from having to remember or ask the person a second time for this information. In an example, the system can then identify fields from the document that cannot be completed from the conversation thus far. This additional information can be gathered using several techniques. For example, the system can query third party data sources (e.g., a government agency, credit agency, etc.) to acquire the data. Here, as opposed to traditional federated data systems, there need not be coordination between the system and the third party data source other than a standard access technique. Thus, the complexity of maintaining privacy, transferring data, versioning, etc., is avoided from traditional federated data techniques. and prompt the representative to ask questions of the person to acquire the information to complete these fields.

While using agents of the system to query third party data services can be quick and relieve the human parties from spending additional time filling out document fields, there may be situations in which the document field cannot be automatically populated from either the conversation thus far or the third party data. Thus, in an example, the system is configured to provide prompts (e.g., questions, scripts, etc.) to the representative to guide the conversation into obtaining this missing information from the person. The result is an efficient conversation with a person to acquire the information needed to complete forms that will enable the representative to provide services offered by an organization. Additional details and examples are provided below.

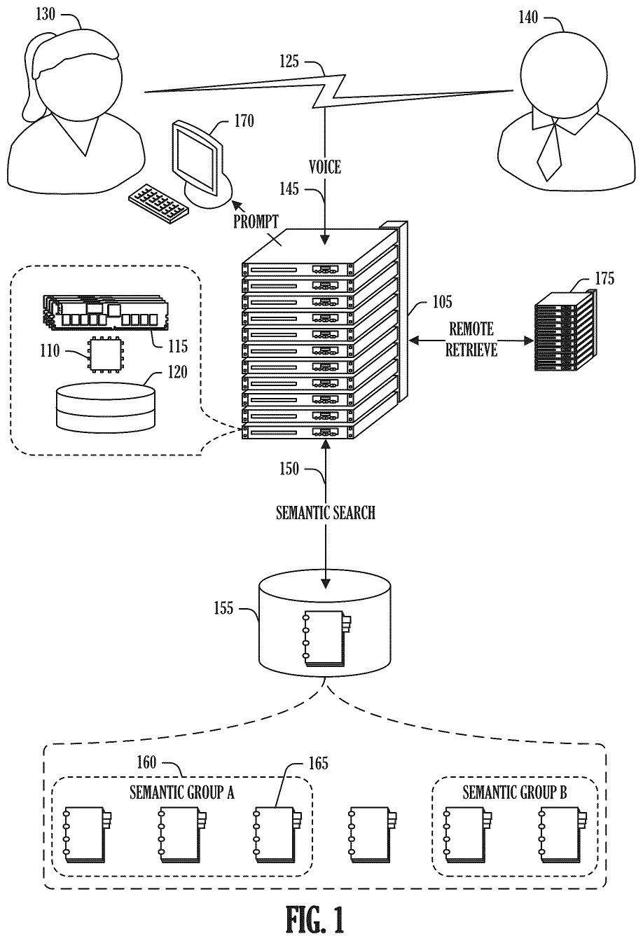

FIG. 1 is a block diagram of an example of an environment including a system 105 for natural language processing over a document repository (e.g., the DM system 155), according to an embodiment. The system 105 includes processing circuitry 110, storage 120 (e.g., power-stable storage such as a hard drive, solid state drive, etc.), and memory 115. The memory 115 is generally used to maintain running state information for the system 105 that is generally discarded between system power cycles or restarts. The memory 115 and the storage 120 are both forms of computer readable media. The processing circuitry 110 or software residing in the memory 115 or storage 120 executing on the processing circuitry 110 configure the system 105 to perform various operations when in operation.

The system 105 has an interface 145 configured to capture a conversation between a first person 140 and a second person 130. This interface 145 can be configured to connect to a microphone, a telephone, a telephone system, or a transcript generated from the conversation 125. In an example, the conversation includes mixed vocal and text media. For example, if the first person 140 is talking to the second person 130 using both speaking and text via a chat in the terminal 170. In this case, the two media, voice and text, can be combined by the system 105 or prior to delivery to the system 105.

The system 105 includes an interface 150 to DM system 155. This interface 150 can include a network interface, intra-system interface (e.g., an interface conforming to a Peripheral Component Interconnect Express (PCIe) family of standards). In an example, the system 105 includes an interface to a remote data store 175. Generally, this interface will be a network connection to access the remote data store 175.

Within the context of the illustrated system 105, the system 105 is configured to perform NLP over the document repository of the DM system 155. As noted above, this NLP enables the system 105 to contextualize aspects of the conversation 125 from the first person 140 in the context of the document repository. Thus, if the first person 140 is applying for government benefits that relate to a semantic group of documents, such as semantic group A 160, and other parts of the conversation 125 address the weather that is not related to any documents in the DM system 155, then the parts of the conversation relating to the request for benefits are evaluated as “the request” based on the context of the document repository in the DM system 155.

When in operation (e.g., when powered up, loading, executed, etc.) the processing circuitry 110 is configured to obtain (e.g., retrieve or receive) text from a portion of the conversation 125 between the first person 140 and the second person 130. In an example, the second person 130 is a representative that is fielding a request from the first person 140 (e.g., a customer, client, etc.). In an example, the first person 140 is making a request to the second person 130 in (e.g., during) the portion of the conversation. In an example, the second person 130 interacts with the first person by speaking, either in-person (e.g., in an office across a desk or in a conference room) or over the telephone. The terminal 170, a microphone in an office, a phone, a telephony system over which the conversation 125 is taking place, or other recording device can be used to capture the voice-based portions of the conversation 125. In an example, the terminal 170 is configured to perform a text-to-speech operation to convert a sound recording of the conversation 125 into text. In an example, the audio of the conversation 125 is provided to the system 105 and the system 105 is configured to convert the audio to text.

The processing circuitry 110 is configured to evaluate a semantic match between parts of the text and documents in the DM system 155 (e.g., the repository or document repository). This evaluation of semantic matching enables the processing circuitry 110 to determine the request made by the first person 140. Here, semantic matching refers to several language processing techniques that enable classification of “meaning” with text such that two semantically similar texts are likely to be considered to have similar meaning when considered by a human observer. For example, if to documents represent stories that have similar nouns performing similar verbs, a conclusion may be made that the stories are similar. Thus, in an example, determining the request from the text includes determining the parts of text using an NLP technique to identify nouns, adjectives, verbs, or adverbs in the text. In an example, the parts of text are a combination of multiple related words, relationships between words determined by the natural language processing technique. Here, NLP techniques can be used to group the utterances of the conversation 125 into sentences or phrases that can be considered. In an example, the natural language processing technique is an LLM. While other ANN techniques can be applied, the accuracy and power of LLMs causes the LLM to be a natural choice for segmenting the conversation. While it is possible to perform semantic matching on large portions of text, such as an entire book, or the entire conversation 125, splitting the conversation 125 into sentences or phrases enables identification of the request in these individual elements, likely increasing the accuracy of the approach.

Different techniques can be employed to support the evaluation of the semantic match between the parts of the text of the conversation 125 and the documents in the DM system 155. For example, Term Frequency Inverse Document Frequency (TF-IDF) is a technique whereby terms are counted in documents. Terms that appear at a higher rate between two documents versus the rest of the document considered, but do not occur very often in the corpus of documents, can be considered to indicate semantic similarity between these two documents. Generally, these techniques produce a vector in a multidimensional space. For example, each document in a corpus can be considered to be a dimension and the vector for a term is a count of the term in each document. Generally, vectors with a small Euclidean distance are considered the most similar. Other distance measurements, such as cosine similarity, can be used on the vector space. Cosine similarity evaluates the similarity of content without concern for the amount of content while the Euclidean distance further considers the amount of content. For example, if two documents discuss mammals, but one document is a single page pamphlet and the second document is a thousand page treatise, the cosine similarity will likely be high while the Euclidean distance may be greater because, while the two vectors point in the same direction, the greater content of the treatise can cause the vector for the treatise to be much longer than that of the pamphlet.

In an example, evaluating the semantic match between parts of the text and documents in the DM system 155 include calculating an embedding vector for the parts of the text. Here, an embedding vector refers to a technique employed by many LLM models. The LLM model is trained to produce the embedding vector to represent meaning, within the context of a text as well as within the context of the training materials. This is often considered an “encoder” in a transformer, although some “decoder only” LLMs also produce embeddings. In an example, evaluating the semantic match between parts of the text and documents in the DM system 155 includes identifying a set of documents—such as semantic group A 160—based on a similarity metric between the embedding vector of the part of the text and documents in the set of documents. In an example, the similarity metric is one of cosine similarity, Euclidean distance, or dot product similarity. In these examples, each document, such as the document 165, have an embedding calculated and stored. Often a vector database is used to perform similarity lookups based on an embedding vector, the embedding vector for the document 165 operating as an index in the vector database.

In an example, documents are selected from the DM system 155 to be included in the set of documents based on a similarity metric being within a threshold of similarity. As illustrated, the documents in the semantic group A 160 satisfy a similarity threshold to a part of the conversation 125 while the other documents in the DM system 155 do not. Thus, this part of the text of the conversation is related to the documents in the semantic group A 160 and not the documents in the semantic group B. In an example, documents are selected from the DM system 155 to be included in the set of documents based on a defined cardinality of the set of documents, the set of documents having a highest rank under the similarity metric. Here, the cardinality parameter specifies, for example, ten documents. Thus, the top ten documents most similar to the part of text under the similarity metric are in the semantic group A 160.

At this stage, the documents in the semantic group A 160 can provide a list of available requests that the second person can address. For example, if the documents in the semantic group A 160 are different kind of loan applications, then the request is determined to be a loan. If the documents are different types of wills, then the request can be considered to be the creation or amendment of a will. Even if the conversation 125 includes other aspects that may be considered “requests” in a more literal sense, such as a request to correct to behavior of a wayward child, this is not a request that the second person 130 can address and so it is not considered a true request with respect to the conversation 125. Accordingly, the intent and meaning of the conversation 125 is derived from semantic similarity to the documents in the DM system 155 that represent the capabilities of the second person 130 or an organization or system represented by the second person 130.

Once the request of the first person 140 is determined, the document 165 from the DM system 155 is selected based on the request. For example, if a person is requesting medical attention, the document 165 can be a hospital admission form. Which specific document in the semantic group A 160 that is selected can depend upon additional context in the request or in other parts of the conversation. Accordingly, if the person is seeking medical attention for a headache and slight fever, the document 165 can be an admission form to an urgent care office rather than an emergency room. In an example, the document 165 includes a set of fields.

When the document 165 includes a set of fields, generally, these fields are completed (e.g., filled out) by the first person 140 or the second person 130, or both. As noted above, it is beneficial if the first person 140 is not forced to repeat information to complete these fields. It is also beneficial if the second person 130 need not remember every element of the conversation 125 in order to avoid asking the first person 140 for the information a second time. Accordingly, the processing circuitry 110 is configured to populate a field in the set of fields from the text of the conversation 125. As the conversation 125 continues, additional details become available to the system 105 that can be used to populate the fields of the document 165. Accordingly, in an example, a second field of the set of fields is populated from a second text of a second portion of the conversation.

In an example, the processing circuitry 110 is configured to retrieve data from an external source (e.g., the remote data store 175) in response to identifying a second field of the set of fields based on an inability to populate the second field from material in the conversation 125. Consider a situation in which a form asks for a list of family members, for example, to use as emergency contacts. In this example, the remote data store 175 can be a social media account for the first person 140 that can be accessed to populate the emergency contact list. Other examples of the remote data store 175 can include a government identification database, a credit database, or other facility configured to share information. Thus, neither the first person 140 nor the second person 130 need act to gather this information. Note that, this procedure is different than incorporating a federated data source. Thus, there is no need to coordinate with the remote data store 175 outside of a connection to retrieve the data for the field. There is no coordination used to pre-fetch this data, nor to ensure security measures for holding different types of personal or otherwise sensitive data in a single database. Rather, the interface to the remote data store 175, as with connections to other, unillustrated, remoted data stores, comply with standard remote access procedures. Accordingly, a flexible and secure system is realized.

In the previous examples, the processing circuitry 110 is configured to complete fields of the document 165 using either the content of the conversation 125 itself, or by accessing one or more remote data stores, such as the remote data store 175. However, there may still be fields for which these two sources are missing data. In an example, the processing circuitry 110 is configured to identify such a field (e.g., a third field) of the set of fields that is unfilled and to prompt the second person 130 to request data from the first person 140 to fill the third field. Such a prompt can include a textual prompt displayed to the terminal 170, a voice prompt in a telephone, earpiece, or other device, or another mechanism (e.g., haptic) in order to signal the second person 130 to ask the question. Consider a representative (e.g., the second person 130) receiving a request from a customer (e.g., the first person 140) in an office. In this case, the terminal 170 can include a chat or other user interface for the representative, the chat providing question prompts to the representative to ask the customer. As the conversation progresses, these questions, if answered, put the data for the as-yet unfilled fields into the text of the conversation 125, enabling the system 105 to complete these fields.

Accordingly, the DM system 155, and the documents contained therein, enable a form of NLP to be performed on the conversation. A request from the first person 140, that can be handled by an organization, is identified. From this request, an appropriate document (e.g., document 165) is identified. All of this has occurred without the second person 130 using any special skills for document querying or retrieval, nor in wasting time in identifying pertinent documents. Further, the conversation itself provides the data used to complete the document or provides direction to retrieve this data either from the remote data store 175, or to prompt questions to provide such data into the conversation 125. Accordingly, the first person 140, making the request, need not repeat information, or provide information available elsewhere, resulting in a more efficient and enjoyable experience.

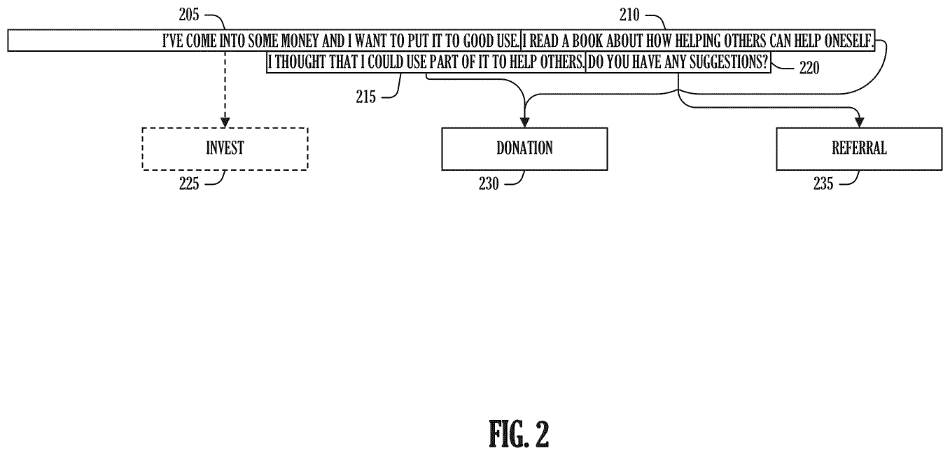

FIG. 2 illustrates an example of fining a semantic match between portions of a conversation and a document repository, according to an embodiment. As illustrated, an NLP technique is used to partition a conversion into several segments (e.g., sentences). These segments are first segment 205, a second segment 210, a third segment 215, and a fourth segment 220. As a simplification, the documents in the document repository are categorized into a donation category 230 and a referral category 235. The invest category 225 is a semantic category to which the first segment 205 pertains but is not within the document repository.

In this context, the semantic match for the second segment 210 and the third segment 215 most closely align with the donation category. The semantic match for the fourth segment most closely aligns with the referral category. Because the document repository has documents for both of these categories, this means that the request, given the context of the conversation, is either a request for a donation or for a referral. Note that the first segment 205, that is semantically similar to the invest category 225, may lead to a misunderstanding of the request in a general sense. That is, without the context of the document repository, a general purpose intent analysis may lead a system to infer a request other than intended by the requestor.

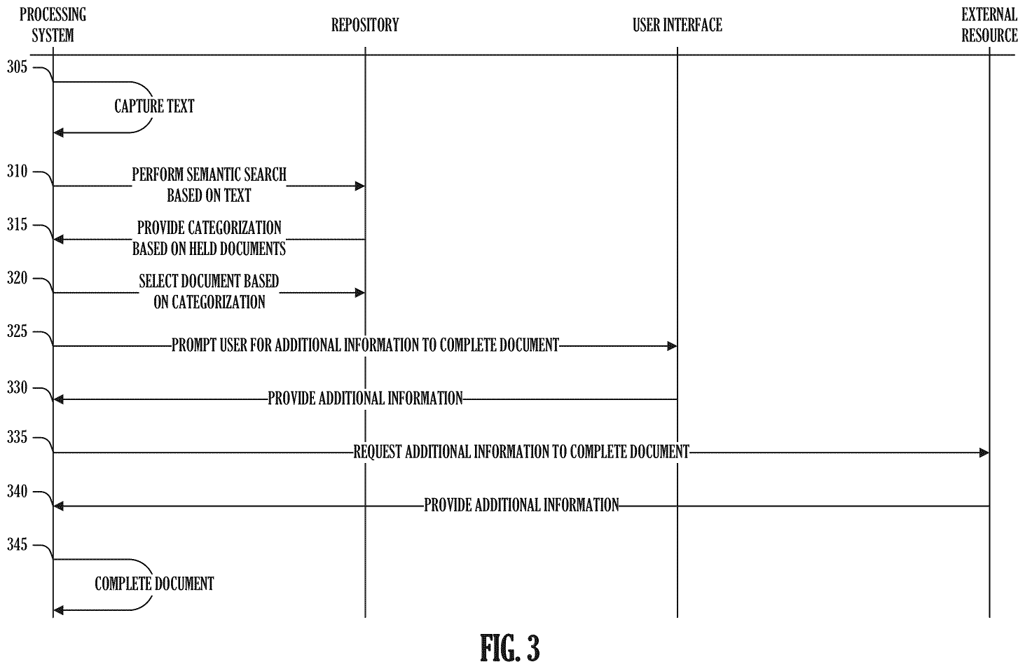

FIG. 3 illustrates an example of signaling between components, according to an embodiment. In this example, the system captures text of a conversation (operation 305). The system performs a semantic search (operation 310) of a part of the text over a document repository, such as a cosine similarity match due to the difference in size of a phrase from the conversation and a document in a document repository. The document repository provides a response (e.g., a group of documents, a categorization of documents, etc.) configured to identify a group of documents semantically similar to the portion of the text (operation 315).

The system selects a document (e.g., based on the categorization of documents) from the repository (operation 320). As noted above, information previously part of the conversation can be used by the system to populate fields of the document. However, if such information in unavailable, the system can prompt the user for additional information (operation 325). The user can then provide such information, via a user interface (operation 330). The system can also request additional information from an external resource (operation 335). The remote resource can then respond with the requested data (operation 340). Once the data to complete the document fields is gathered, the system can complete the document (operation 345).

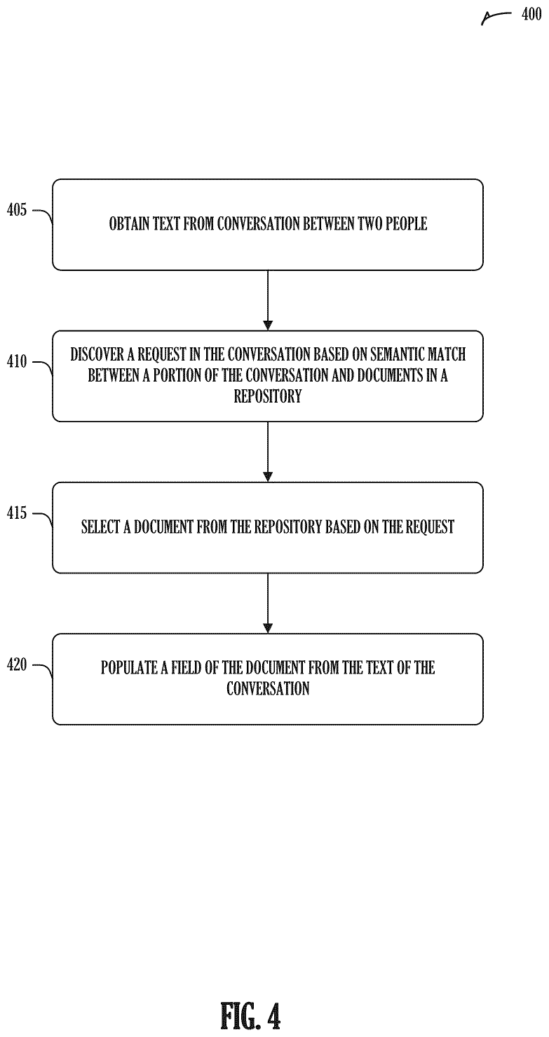

FIG. 4 illustrates a flow diagram of an example of a method 400 for natural language processing over a document repository, according to an embodiment. The operations of the method 400 are performed by computational hardware, such as that described above or below (e.g., processing circuitry).

At operation 405, text is obtained from a portion of a conversation between a first person and a second person. In an example, the first person is making a request to the second person in (e.g., during) the portion of the conversation.

At operation 410, the request is determined from the text by evaluating a semantic match between parts of the text and documents in a repository. In an example, determining the request from the text includes determining the parts of text using a natural language processing technique to identify nouns, adjectives, verbs, or adverbs in the text. In an example, the parts of text are a combination of multiple related words, relationships between words determined by the natural language processing technique. In an example, the natural language processing technique is a large language model (LLM) artificial neural network (ANN).

In an example, evaluating the semantic match between parts of the text and documents in the repository includes calculating an embedding vector for the parts of the text. In an example, evaluating the semantic match between parts of the text and documents in the repository includes identifying a set of documents based on a similarity metric between the embedding vector of a part of the text and documents in the set of documents. In an example, the similarity metric is one of cosine similarity, Euclidean distance, or dot product similarity.

In an example, documents are selected from the repository to be included in the set of documents based on a defined cardinality of the set of documents, the set of documents having a highest rank under the similarity metric. In an example, documents are selected from the repository to be included in the set of documents based on a similarity metric being within a threshold of similarity.

At operation 415, a document from the repository is selected based on the request once determined. In an example, the document includes a set of fields.

At operation 420, a field in the set of fields is populated from the text. In an example, a second field of the set of fields is populated from a second text of a second portion of the conversation. In an example, the operations of the method 400 include retrieving data from an external source in response to identifying a second field of the set of fields based on an inability to populate the second field from material in the conversation. In an example, the operations of the method 400 include further include identifying a third field of the set of fields that is unfilled following retrieval of data from the external source, and prompting the second person to request data from the first person to fill the third field.

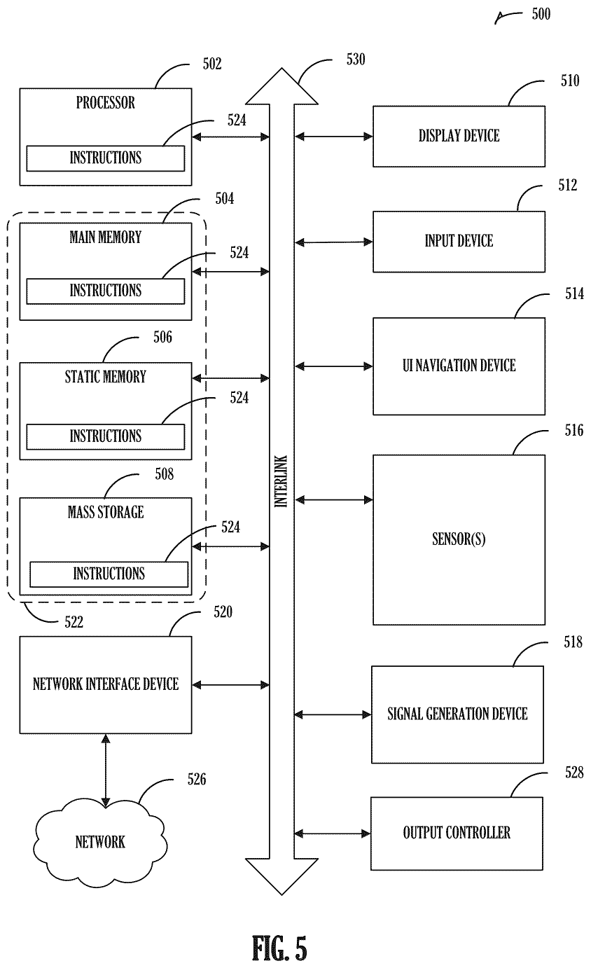

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices, magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is an apparatus for natural language processing over a document repository, the apparatus comprising: a memory including instructions; and processing circuitry that, when in operation, is configured by the instructions to: obtain text from a portion of a conversation between a first person and a second person, the first person making a request in the portion of the conversation to the second person; determine the request from the text by evaluating a semantic match between parts of the text and documents in a repository; select a document from the repository based on the request once determined, the document including a set of fields; and populate a field in the set of fields from the text.

In Example 2, the subject matter of Example 1, wherein, to determine the request from the text, the processing circuitry is configured to determine the parts of text using a natural language processing technique to identify a noun, an adjective, a verb, or an adverb in the text.

In Example 3, the subject matter of Example 2, wherein the parts of text are a combination of multiple related words, relationships between words determined by the natural language processing technique.

In Example 4, the subject matter of Example 3, wherein the natural language processing technique is a large language model (LLM) artificial neural network (ANN).

In Example 5, the subject matter of any of Examples 1-4, wherein, to evaluate the semantic match between parts of the text and documents in the repository, the processing circuitry is configured to calculate an embedding vector for the parts of the text.

In Example 6, the subject matter of Example 5, wherein, to evaluate the semantic match between parts of the text and documents in the repository, the processing circuitry is configured to identify a set of documents based on a similarity metric between the embedding vector of a part of the text and documents in the set of documents.

In Example 7, the subject matter of Example 6, wherein the similarity metric is one of cosine similarity, Euclidean distance, or dot product similarity.

In Example 8, the subject matter of any of Examples 6-7, wherein the processing circuitry is configured to select documents from the repository to be included in the set of documents based on a defined cardinality of the set of documents, the set of documents having a highest rank under the similarity metric.

In Example 9, the subject matter of any of Examples 6-8, wherein the processing circuitry is configured to select documents from the repository to be included in the set of documents based on the similarity metric being within a threshold of similarity.

In Example 10, the subject matter of any of Examples 1-9, wherein a second field of the set of fields is populated from a second text of a second portion of the conversation.

In Example 11, the subject matter of any of Examples 1-10, wherein the processing circuitry is configured to retrieve data from an external source in response to identifying a second field of the set of fields based on an inability to populate the second field from material in the conversation.

In Example 12, the subject matter of Example 11, wherein the processing circuitry is configured to: identify a third field of the set of fields that is unfilled following retrieval of data from the external source; and prompt the second person to request data from the first person to fill the third field.

Example 13 is a method for natural language processing over a document repository, the method comprising: obtaining text from a portion of a conversation between a first person and a second person, the first person making a request in the portion of the conversation to the second person; determining the request from the text by evaluating a semantic match between parts of the text and documents in a repository; selecting a document from the repository based on the request once determined, the document including a set of fields; and populating a field in the set of fields from the text.

In Example 14, the subject matter of Example 13, wherein determining the request from the text includes determining the parts of text using a natural language processing technique to identify a noun, an adjective, a verb, or an adverb in the text.

In Example 15, the subject matter of Example 14, wherein the parts of text are a combination of multiple related words, relationships between words determined by the natural language processing technique.

In Example 16, the subject matter of Example 15, wherein the natural language processing technique is a large language model (LLM) artificial neural network (ANN).

In Example 17, the subject matter of any of Examples 13-16, wherein evaluating the semantic match between parts of the text and documents in the repository includes calculating an embedding vector for the parts of the text.

In Example 18, the subject matter of Example 17, wherein evaluating the semantic match between parts of the text and documents in the repository includes identifying a set of documents based on a similarity metric between the embedding vector of a part of the text and documents in the set of documents.

In Example 19, the subject matter of Example 18, wherein the similarity metric is one of cosine similarity, Euclidean distance, or dot product similarity.

In Example 20, the subject matter of any of Examples 18-19, wherein documents are selected from the repository to be included in the set of documents based on a defined cardinality of the set of documents, the set of documents having a highest rank under the similarity metric.

In Example 21, the subject matter of any of Examples 18-20, wherein documents are selected from the repository to be included in the set of documents based on the similarity metric being within a threshold of similarity.

In Example 22, the subject matter of any of Examples 13-21, wherein a second field of the set of fields is populated from a second text of a second portion of the conversation.

In Example 23, the subject matter of any of Examples 13-22, comprising retrieving data from an external source in response to identifying a second field of the set of fields based on an inability to populate the second field from material in the conversation.

In Example 24, the subject matter of Example 23, comprising: identifying a third field of the set of fields that is unfilled following retrieval of data from the external source; and prompting the second person to request data from the first person to fill the third field.

Example 25 is a machine readable media including instructions for natural language processing over a document repository, the instructions, when executed by processing circuitry, cause the processing circuitry to perform operations comprising: obtaining text from a portion of a conversation between a first person and a second person, the first person making a request in the portion of the conversation to the second person; determining the request from the text by evaluating a semantic match between parts of the text and documents in a repository; selecting a document from the repository based on the request once determined, the document including a set of fields; and populating a field in the set of fields from the text.

In Example 26, the subject matter of Example 25, wherein determining the request from the text includes determining the parts of text using a natural language processing technique to identify a noun, an adjective, a verb, or an adverb in the text.

In Example 27, the subject matter of Example 26, wherein the parts of text are a combination of multiple related words, relationships between words determined by the natural language processing technique.

In Example 28, the subject matter of Example 27, wherein the natural language processing technique is a large language model (LLM) artificial neural network (ANN).

In Example 29, the subject matter of any of Examples 25-28, wherein evaluating the semantic match between parts of the text and documents in the repository includes calculating an embedding vector for the parts of the text.

In Example 30, the subject matter of Example 29, wherein evaluating the semantic match between parts of the text and documents in the repository includes identifying a set of documents based on a similarity metric between the embedding vector of a part of the text and documents in the set of documents.

In Example 31, the subject matter of Example 30, wherein the similarity metric is one of cosine similarity, Euclidean distance, or dot product similarity.

In Example 32, the subject matter of any of Examples 30-31, wherein documents are selected from the repository to be included in the set of documents based on a defined cardinality of the set of documents, the set of documents having a highest rank under the similarity metric.

In Example 33, the subject matter of any of Examples 30-32, wherein documents are selected from the repository to be included in the set of documents based on the similarity metric being within a threshold of similarity.

In Example 34, the subject matter of any of Examples 25-33, wherein a second field of the set of fields is populated from a second text of a second portion of the conversation.

In Example 35, the subject matter of any of Examples 25-34,

wherein the operations comprise retrieving data from an external source in response to identifying a second field of the set of fields based on an inability to populate the second field from material in the conversation.

In Example 36, the subject matter of Example 35, wherein the operations comprise: identifying a third field of the set of fields that is unfilled following retrieval of data from the external source; and prompting the second person to request data from the first person to fill the third field.

Example 37 is a system for natural language processing over a document repository, the system comprising: means for obtaining text from a portion of a conversation between a first person and a second person, the first person making a request in the portion of the conversation to the second person; means for determining the request from the text by evaluating a semantic match between parts of the text and documents in a repository; means for selecting a document from the repository based on the request once determined, the document including a set of fields; and means for populating a field in the set of fields from the text.

In Example 38, the subject matter of Example 37, wherein the means for determining the request from the text include means for determining the parts of text using a natural language processing technique to identify a noun, an adjective, a verb, or an adverb in the text.

In Example 39, the subject matter of Example 38, wherein the parts of text are a combination of multiple related words, relationships between words determined by the natural language processing technique.

In Example 40, the subject matter of Example 39, wherein the natural language processing technique is a large language model (LLM) artificial neural network (ANN).

In Example 41, the subject matter of any of Examples 37-40, wherein the means for evaluating the semantic match between parts of the text and documents in the repository include means for calculating an embedding vector for the parts of the text.

In Example 42, the subject matter of Example 41, wherein the means for evaluating the semantic match between parts of the text and documents in the repository include means for identifying a set of documents based on a similarity metric between the embedding vector of a part of the text and documents in the set of documents.

In Example 43, the subject matter of Example 42, wherein the similarity metric is one of cosine similarity, Euclidean distance, or dot product similarity.

In Example 44, the subject matter of any of Examples 42-43,

wherein documents are selected from the repository to be included in the set of documents based on a defined cardinality of the set of documents, the set of documents having a highest rank under the similarity metric.

In Example 45, the subject matter of any of Examples 42-44, wherein documents are selected from the repository to be included in the set of documents based on the similarity metric being within a threshold of similarity.

In Example 46, the subject matter of any of Examples 37-45, wherein a second field of the set of fields is populated from a second text of a second portion of the conversation.

In Example 47, the subject matter of any of Examples 37-46, comprising means for retrieving data from an external source in response to identifying a second field of the set of fields based on an inability to populate the second field from material in the conversation.

In Example 48, the subject matter of Example 47, comprising: means for identifying a third field of the set of fields that is unfilled following retrieval of data from the external source; and means for prompting the second person to request data from the first person to fill the third field.
PNUM Example 49 is at least one machine-readable medium including instructions that, when executed by processing circuitry, cause the processing circuitry to perform operations to implement of any of Examples 1-48.
PNUM Example 50 is an apparatus comprising means to implement of any of Examples 1-48.
PNUM Example 51 is a system to implement of any of Examples 1-48.
PNUM Example 52 is a method to implement of any of Examples 1-48.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A non-transitory machine readable media including instructions for natural language processing over a document repository, the instructions, when executed by processing circuitry, cause the processing circuitry to perform operations comprising:
obtaining text from a portion of a conversation between a first person and a second person, the first person making a request in the portion of the conversation to the second person;
determining the request from the text by evaluating a semantic match between parts of the text and documents in a repository;
selecting a document from the repository based on the request once determined, the document including a set of fields; and
populating a field in the set of fields from the text.

2. The non-transitory machine readable media of claim 1, wherein determining the request from the text includes determining the parts of text using a natural language processing technique to identify a noun, an adjective, a verb, or an adverb in the text.

3. The non-transitory machine readable media of claim 2, wherein the parts of text are a combination of multiple related words, relationships between words determined by the natural language processing technique.

4. The non-transitory machine readable media of claim 3, wherein the natural language processing technique is a large language model (LLM) artificial neural network (ANN).

5. The non-transitory machine readable media of claim 1, wherein evaluating the semantic match between parts of the text and documents in the repository includes calculating an embedding vector for the parts of the text.

6. The non-transitory machine readable media of claim 5, wherein evaluating the semantic match between parts of the text and documents in the repository includes identifying a set of documents based on a similarity metric between the embedding vector of a part of the text and documents in the set of documents.

7. The non-transitory machine readable media of claim 6, wherein the similarity metric is one of cosine similarity, Euclidean distance, or dot product similarity.

8. The non-transitory machine readable media of claim 6, wherein documents are selected from the repository to be included in the set of documents based on a defined cardinality of the set of documents, the set of documents having a highest rank under the similarity metric.

9. The non-transitory machine readable media of claim 6, wherein documents are selected from the repository to be included in the set of documents based on the similarity metric being within a threshold of similarity.

10. The non-transitory machine readable media of claim 1, wherein a second field of the set of fields is populated from a second text of a second portion of the conversation.

11. The non-transitory machine readable media of claim 1, wherein the operations comprise retrieving data from an external source in response to identifying a second field of the set of fields based on an inability to populate the second field from material in the conversation.

12. The non-transitory machine readable media of claim 11, wherein the operations comprise:
identifying a third field of the set of fields that is unfilled following retrieval of data from the external source; and
prompting the second person to request data from the first person to fill the third field.

13. A method for natural language processing over a document repository, the method comprising:
obtaining text from a portion of a conversation between a first person and a second person, the first person making a request in the portion of the conversation to the second person;
determining the request from the text by evaluating a semantic match between parts of the text and documents in a repository;
selecting a document from the repository based on the request once determined, the document including a set of fields; and
populating a field in the set of fields from the text.

14. The method of claim 13, wherein determining the request from the text includes determining the parts of text using a natural language processing technique to identify a noun, an adjective, a verb, or an adverb in the text.

15. The method of claim 14, wherein the parts of text are a combination of multiple related words, relationships between words determined by the natural language processing technique.

16. The method of claim 13, wherein evaluating the semantic match between parts of the text and documents in the repository includes calculating an embedding vector for the parts of the text.

17. The method of claim 16, wherein evaluating the semantic match between parts of the text and documents in the repository includes identifying a set of documents based on a similarity metric between the embedding vector of a part of the text and documents in the set of documents.

18. The method of claim 17, wherein the similarity metric is one of cosine similarity, Euclidean distance, or dot product similarity.

19. The method of claim 13, comprising retrieving data from an external source in response to identifying a second field of the set of fields based on an inability to populate the second field from material in the conversation.

20. The method of claim 19, comprising:
identifying a third field of the set of fields that is unfilled following retrieval of data from the external source; and
prompting the second person to request data from the first person to fill the third field.
